(19) United States
(12) Patent Application Publication
(10) Pub. No.: US 2018/0104126 A1
(43) Pub. Date: Apr. 19, 2018

(54) PATIENT SUPPORT APPARATUS WITH STABILIZATION

(71) Applicant: Stryker Corporation, Kalamazoo, MI (US)

(72) Inventors: Anish Paul, Portage, MI (US); Joseph Adam Upchurch, Kalamazoo, MI (US); Matthew A. Cutler, Portage, MI (US); Tyler Joseph Ethen, Portage, MI (US)

(21) Appl. No.: 15/730,343

(22) Filed: Oct. 11, 2017

Related U.S. Application Data
(60) Provisional application No. 62/408,120, filed on Oct. 14, 2016.

(51) Int. Cl. A61G 15/02; A61G 15/00; A61G 13/04; A61G 13/10

(52) U.S. Cl. CPC A61G 15/02; A61G 15/002; A61G 13/1225; A61G 13/104; A61G 13/04

(57) ABSTRACT

A patient support apparatus includes a base, a seat supported by the base and a backrest pivotable between an upright position and a reclined position. In one embodiment, a backrest support member is coupled to the backrest and is adapted to move between a stowed position in which the backrest support member does not support the backrest and a deployed position in which the backrest support member does support the backrest. Movement to the deployed position occurs in response to activation of an emergency control. In other embodiments, the base includes a portion that moves into an extended position underneath the backrest when the backrest is in the reclined position. Movement of the base portion to the extended position also occurs in response to activation of an emergency control.

### CROSS-REFERENCE TO RELATED APPLICATIONS

This application claims priority to U.S. provisional patent application Ser. No. 62/408,120 filed Oct. 14, 2016, by inventors Anish Paul et al. and entitled PATIENT SUPPORT APPARATUS WITH STABILIZATION, the complete disclosure of which is incorporated herein by reference.

### BACKGROUND

The present disclosure relates to patient support apparatuses, such as, but not limited to, beds, cots, stretchers, recliners, chairs, operating tables, and the like; and more particularly to one or more stabilization features of the patient support apparatus that help stabilize the patient support apparatus.

Patient support apparatuses often include a backrest that can pivot between an upright position and a fully reclined position. In emergency situations, the backrest of the patient support apparatus is desirably moved to a fully reclined position when the patient's heart has stopped beating, or when the application of cardiopulmonary resuscitation (CPR) is desirable. Some prior art patient support apparatuses, however, are not ideally suited for supporting patients while CPR is applied.

### SUMMARY

In its various embodiments, the present disclosure provides a patient support apparatus that includes one or more stabilization features that are selectively deployed in emergency situations where the application of CPR is desirable. In some such embodiments, a backrest support member is provided to provide additional support to the backrest and/or to more rigidly maintain the fixed position of the backrest, thereby increasing the effectiveness of compressions applied to the patient's chest. The backrest support member thereby increases the stability of the patient support apparatus when the backrest is reclined in emergency situations. In some embodiments, the backrest support member includes a strut that is deployed. In other embodiments, the patient support apparatus additionally includes a leg rest support member to provide support to the leg rest. In yet other embodiments, the patient support apparatus includes an expandable base. The patient support apparatus may also include a combination of a backrest support member and an expandable base. These and/or other features are disclosed in the various embodiments discussed herein.

According to one embodiment of the disclosure, a patient support apparatus includes a base, a seat support by the base, a backrest, and a backrest support member. The backrest is pivotable between an upright position and a reclined position. The backrest support member is coupled to the backrest and moves between a stowed position in which the backrest support member does not contact a support and a deployed position in which the backrest support member does contact the support.

According to other aspects, the support is a floor on which the patient support apparatus is positioned. In some embodiments, the backrest support member has a first end pivotably coupled to the backrest and a second end which abuts the floor when the backrest support member is in the deployed position. In other embodiments, the backrest support member moves between the stowed position and the deployed position when an angle of the backrest relative to the floor satisfies a predetermined threshold. In still other embodiments, the seat is adapted to move to a height in which the backrest support member contacts the floor when the backrest support member is deployed.

The patient support apparatus also includes, in some embodiments, a leg rest pivotable between a retracted position and an extended position and a leg rest support member. The leg rest support member moves between a stowed position in which the leg rest support member does not contact the floor and a deployed position in which the leg rest support member contacts the floor. The leg rest support member is adapted to move into the deployed position when the backrest support member moves into the deployed position. In other embodiments, the leg rest and the leg rest support member are adapted to move to the extended and deployed positions, respectively, when the backrest support member moves to the deployed position.

According to other aspects, the backrest support member automatically moves into the deployed position when a CPR control is activated. In such situations, the backrest pivots to the reclined position and the backrest support member moves to the deployed position. In some embodiments, the backrest support member comprises a telescoping member.

According to another embodiment, the patient support apparatus further includes a first actuator for pivoting the backrest, a second actuator for moving the backrest support member, and a control system adapted to coordinate movement of the first and second actuators. The patient support apparatus can further include a user interface having an electrically operated button, wherein selection of the electrically operated button causes the control system to coordinate movement of the first and second actuators to pivot the backrest into a fully reclined position and to deploy the backrest support member.

In still another embodiment, the patient support apparatus further includes one or more manual actuators for moving the backrest and the backrest support member. An electric motor may be added to supplement the manual force when an emergency control (e.g. CPR) is activated. The electric motor is may be placed in a freewheeling state when the emergency control is activated. Activation of the emergency control may also trigger a manual or electric movement of the backrest to the reclined position if the backrest is not already in the reclined position when the emergency control is activated.

In another embodiment, the backrest support member is only manually moveable into the deployed position. In yet another embodiment, a first control moves the backrest to the reclined position with the backrest support member remaining in the stowed position and a second control moves the backrest to the reclined position with the backrest support member moved to the deployed position. The first control is a non-emergency control and the second control is an emergency control.

According to another embodiment, a patient support apparatus includes a base having a first base portion and a second base portion moveable with respect to the first base portion, a seat supported by the base, a backrest pivotable between an upright position and a reclined position, and a control system adapted to move the second base portion between a retracted position and an extended position underneath the backrest.

In some embodiments, the patient support apparatus includes a leg rest pivotable between a retracted position and an extended position and a third base portion moveable with respect to the first base portion. The control system is adapted to move the third base portion between a retracted position and an extended position underneath the leg rest when the leg rest is in its extended position.

In other embodiments, the control system is adapted to move the backrest between the upright position and the reclined position independent of moving the second base portion between the retracted and extended positions. In some embodiments, the control system is adapted to coordinate movement of the backrest between the upright position and the reclined position with movement of the second base portion between the retracted and extended position.

In yet another embodiment, the patient support apparatus further includes a wheel coupled to the first base portion and a brake for the wheel. The control system places the brake in the braked state when the second base portion moves between the retracted and extended positions. In some embodiments, the brake is moveable between a retracted position and a deployed position in which the brake contacts the floor to inhibit movement of the patient support apparatus relative to the floor. The control system in this embodiment is adapted to deploy the brake when the second base portion moves between the retracted and extended positions.

In other embodiments, a backrest support member is adapted to support the backrest on the second base portion. In some aspects, the patient support apparatus further includes a leg rest movable between a retracted position and an extended position, and a third base portion moveable with respect to the first base portion between a retracted position and an extended position. The patient support apparatus also includes a leg rest support member adapted to support the leg rest on the third base portion.

In other aspects, the backrest support member is mounted to the backrest and adapted to move between a stowed position in which the backrest support member does not contact the second base portion and an extended position in which the backrest support member engages the second base portion. In some embodiments, the control system coordinates the movement of the backrest support member and the second base portion. Additionally, or alternatively, the backrest support member is manually moveable into the deployed position.

According to another embodiment, a user interface includes a control that causes the control system to coordinate movement of the backrest into the reclined position and movement of the second base portion into the extended position. In other embodiments, the control system is adapted to move the second base portion between the retracted and extended positions based on an angle of the backrest with respect to a floor.

According to yet another embodiment, a patient support apparatus includes a base having first and second base portions. The first base portion includes a brake system and the second base portion includes a wheel on which the second base portion is moveable across a floor. A seat is supported by the base and a backrest is pivotable between an upright position and a reclined position. The second base portion is moveable with respect to the first base portion between a retracted position and an extended position underneath the backrest. The second base portion remains in the retracted position when the backrest is in the reclined position and a control is not activated and moves to the extended position when the control is activated.

In some embodiments, the control powers a manual actuator, an electrical actuator, or both. In other embodiments, activation of the control places one or more brakes in a braked state.

In still other embodiments, the patient support apparatus also includes a leg rest and a third base portion. The leg rest is pivotable between a retracted position and an extended position, and the third base portion includes a wheel on which the third base portion is moveable across the floor. The third base portion is moveable with respect to the first base portion between a retracted position and an extended position. The third base portion remains in the retracted position when the leg rest is in the extended position and the control is not activated. The third base portion moves to the extended position when the control is activated. In some embodiments, the third base portion is mechanically or electrically linked to the second base portion such that the two extend and retract together. The control is an emergency control, in some embodiments.

According to another embodiment, the patient support apparatus further includes a first actuator for switching the brake system between a braked state and unbraked state, a second actuator for moving the backrest between the upright and reclined positions, and a third actuator for moving the second base portion between the retracted and extended positions. A control system is also included that causes the third actuator to move the second base portion to the extended position and the first actuator to place the brake system in the braked state when the control is activated and the backrest is moved to the reclined position.

In another embodiment, a backrest support member is adapted to support the backrest on the second base portion. In one embodiment, the backrest support member is mounted to the backrest and adapted to move between a stowed position adjacent the backrest and a deployed position in which the backrest support member engages the second base portion. The backrest support member can be adapted to be manually moved into the deployed position. Alternatively, the backrest support member is mounted on the second base portion.

According to another embodiment, a patient support apparatus includes a base, a seat supported by the base, and a backrest pivotable between an upright position and a reclined position. The backrest includes a first end about which the backrest pivots and a second end, opposite the first end. A backrest support member remains in the stowed position when a non-emergency control is activated and moves into the deployed position to support the backrest when an emergency control is activated.

According to one embodiment, the backrest support member has a first end coupled to the backrest and a second end which contacts one of the base or a floor in the deployed position.

In another embodiment, a leg rest is pivotable between a retracted position and an extended position. The leg rest comprises a first end about which the leg rest pivots and a second end, opposite the first end. A leg rest support member is adapted to move between a stowed position and a deployed position in which the leg rest support member supports the leg rest between the first and second ends. The leg rest support member remains in the stowed position and the leg rest cantilevers from the first end when the leg rest is in the retracted position and an emergency control is not activated. The leg rest support member moves into the deployed position to support the leg rest between the first and second ends when the emergency control is activated. In some aspects, the leg rest support member is adapted to move into the deployed position when the backrest support member moves into the deployed position.

Before the various embodiments disclosed herein are explained in detail, it is to be understood that the claims are not to be limited to the details of operation, to the details of construction, or to the arrangement of the components set forth in the following description or illustrated in the drawings. The embodiments described herein are capable of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the claims to any specific order or number of components. Nor should the use of enumeration be construed as excluding from the scope of the claims any additional steps or components that might be combined with or into the enumerated steps or components.

### BRIEF DESCRIPTION OF THE DRAWINGS

FIG. 1 is a side elevation view of one embodiment of a patient support apparatus according to one aspect of the present disclosure;

FIG. 2 is a side elevation view of the patient support apparatus of FIG. 1 shown with its backrest pivoted to a reclined position and its leg rest extended;

FIG. 3 is a diagram of a control system usable with any of the patient support apparatuses disclosed herein;

FIG. 4 is a side elevation view of the patient support apparatus of FIG. 1 shown with a backrest support member and leg rest support member moved to their deployed positions;

FIG. 5 is a side elevation view of a patient support apparatus according to another embodiment of the present disclosure;

FIG. 6 is a side elevation view of a patient support apparatus according to yet another embodiment of the present disclosure;

FIG. 7 is a side elevation view of a patient support apparatus according to still another embodiment of the present disclosure.

### DETAILED DESCRIPTION OF THE EMBODIMENTS

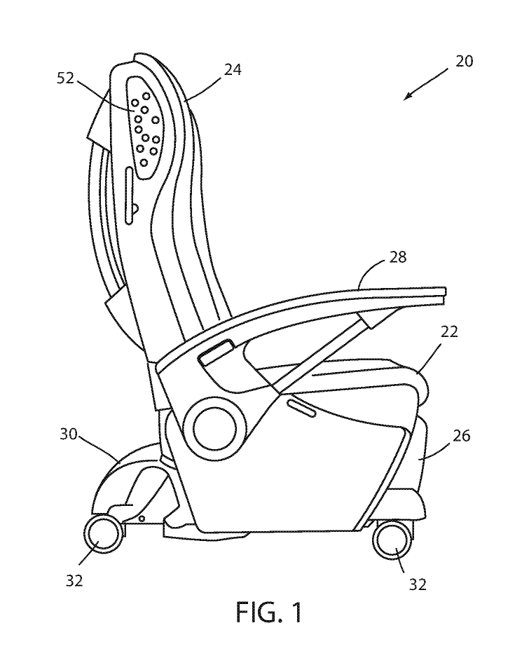

A patient support apparatus 20 according to one embodiment is shown in FIGS. 1, 2, and 4. Patient support apparatus 20 is shown in these drawings to be a recliner. Although the following written description will be made with respect to a recliner, it will be understood by those skilled in the art that the principles disclosed herein may also be incorporated into other types of patient support apparatuses besides recliners, such as, but not limited to, beds, stretchers, cots, surgical tables, chairs, or the like.

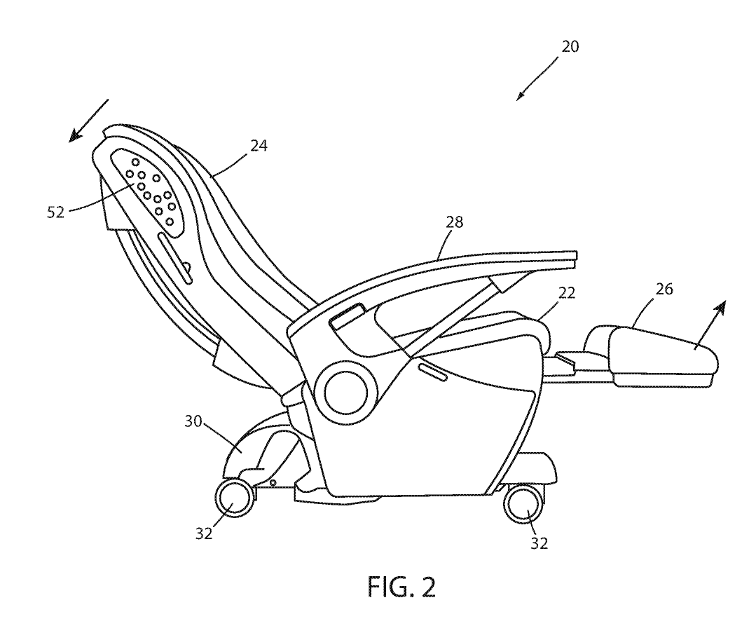

Patient support apparatus 20 includes a seat 22, a backrest 24, a leg rest 26, a pair of armrests 28, a base 30, and a plurality of caster wheels 32 (FIGS. 1 & 2). Patient support apparatus 20 is constructed such that both the height and tilt of seat 22 is adjustable. Further, patient support apparatus 20 is constructed such that backrest 24 is pivotable between a generally upright position, such as shown in FIG. 1, and a virtually infinite number of rearwardly reclined positions, one example of which is illustrated in FIG. 2. Leg rest 26 is constructed such that it is able to be moved between a retracted position, such as shown in FIG. 1, and an extended position in which leg rest 26 is oriented generally horizontally and extends forward from seat 22, such as shown in FIG. 2. Armrests 28 can optionally be constructed such that a user can pivot them between a lowered position and a raised position.

In at least one embodiment, those components of patient support apparatus 20 that are not explicitly described herein are constructed in accordance with any of the embodiments disclosed in commonly assigned, co-pending U.S. patent application Ser. No. 14/212,323 filed Mar. 14, 2014, by inventors Christopher Hough et al. and entitled MEDICAL SUPPORT APPARATUS, the complete disclosure of which is incorporated herein by reference. The non-emergency movement and control of patient support apparatus 20 may also be carried out in accordance with the disclosure of commonly assigned, co-pending U.S. patent application Ser. No. 14/801,167 filed Jul. 16, 2015, by inventors Anish Paul et al. and entitled MEDICAL SUPPORT APPARATUS, the complete disclosure of which is also incorporated herein by reference. Patient support apparatus 20 may also be constructed in other manners besides those described in these two commonly assigned patent applications.

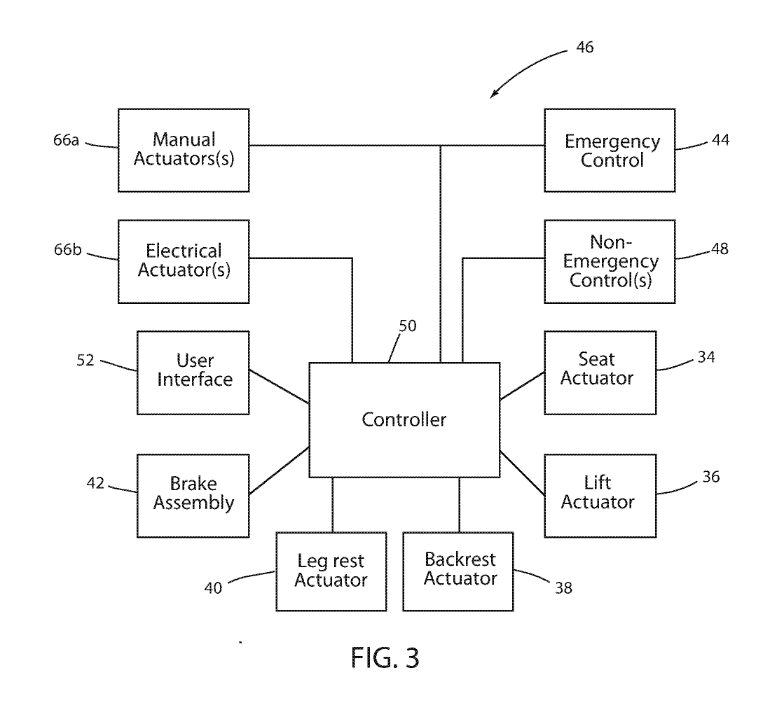

FIG. 3 shows one example of a control system 46 that may be incorporated into the patient support apparatus 20 of FIG. 1. Control system 46 includes a seat actuator 34, a lift actuator 36, a backrest actuator 38, a leg rest actuator 40, a brake assembly 42, an emergency control 44, a non-emergency control 48, one or more manual actuators 66a, one or more electrical actuators 66b, and a controller 50. Each of actuators 34, 36, 38, and 40 are motorized linear actuators that are designed to linearly extend and retract under the control of controller 50. Controller 50 is in communication with one or more user interfaces 52 that may be positioned on each side of backrest 24 (FIGS. 1 and 2). User interface 52 is manipulated by a user in order to control the movement and other functions of patient support apparatus 20.

Controller 50 includes any and all electrical circuitry and components necessary to carry out the functions and algorithms described herein, as would be known to one of ordinary skill in the art. Generally speaking, controller 50 may include one or more microcontrollers, microprocessors, and/or other programmable electronics that are programmed to carry out the functions described herein. It will be understood that controller 50 may also include other electronic components that are programmed to carry out the functions described herein, or that support the microcontrollers, microprocessors, and/or other electronics. The other electronic components include, but are not limited to, one or more field programmable gate arrays, systems on a chip, volatile or nonvolatile memory, discrete circuitry, integrated circuits, application specific integrated circuits (ASICs) and/or other hardware, software, or firmware, as would be known to one of ordinary skill in the art. Such components can be physically configured in any suitable manner, such as by mounting them to one or more circuit boards, or arranging them in other manners, whether combined into a single unit or distributed across multiple units. Such components may be physically distributed in different positions or they may reside in a common location. When physically distributed, the components may communicate using any suitable serial or parallel communication protocol, such as, but not limited to, CAN, LIN, Firewire, I-squared-C, RS-232, RS-485, universal serial bus (USB), etc. One or more of the components may be located on the chair or at a location remote from the chair.

Non-emergency controls 48 are used by the occupant of patient support apparatus 20 (or a caregiver associated therewith) when he or she desires to change the position and/or orientation of any of the seat 22, backrest 24, and/or leg rest 26. These changes are implemented by controller 50 controlling the corresponding seat actuator 34, lift actuator 36, backrest actuator 38, and leg rest actuator 40. Extension and retraction of the seat actuator 34 causes seat 22 to pivot about a seat pivot axis. Extension and retraction of lift actuator 36 causes a frame (not shown) supporting the seat 22 to rise when lift actuator 36 extends and lower when lift actuator 36 retracts, thus raising and lowering the seat 22. In some embodiments, backrest 24 and leg rest 26 are also mounted to the frame such that raising and lowering the frame simultaneously raises and lowers the height of seat 22, backrest 24, and leg rest 26. However, extending and retracting lift actuator 36 does not, by itself, change the angular orientations of any of leg rest 26, backrest 24, and/or seat 22, either with respect to each other or with respect to the floor.

Backrest actuator 38 is mounted to backrest 24 and to the seat frame (not shown). The extension and retraction of backrest actuator 38 therefore causes backrest 24 to pivot with respect to the seat frame. More specifically, when backrest actuator 38 extends, backrest 24 rotates in a counterclockwise direction in FIG. 2. In contrast, when backrest actuator 38 retracts, backrest 24 rotates in a clockwise direction in FIG. 2. In this manner, backrest actuator 38 controls the angle of backrest 24 with respect to the floor (or another fixed reference).

Leg rest actuator 40 is mounted to the seat frame and to leg rest 26. The extension of leg rest actuator 40 therefore pivots leg rest 26 from a retracted position (e.g. FIG. 1) to an extended position in front of seat 22 (FIG. 2). The physical construction of leg rest 26 may take on any of the forms disclosed in the commonly assigned U.S. patent application Ser. No. 14/212,253 mentioned above, whose disclosure is incorporated completely herein by reference. Other physical constructions of leg rest 26 are also possible. The extension and retraction of leg rest actuator 40 changes the orientation of leg rest 26 with respect to the seat frame. The orientation of leg rest 26 with respect to seat frame does not change based on the extension or contraction of any other actuators 34, 36, or 38. The orientation of leg rest 26 with respect to the floor (or some other fixed reference), however, changes when the seat 22 is pivoted by seat actuator 34, or when leg rest actuator 40 pivots leg rest 26.

Each of the actuators 34-40 is powered by a direct current (DC) electrical motor. That is, each of the actuators 34-40 extends or retracts in response to its associated motor being driven in one direction or its opposite direction. The control of each motor is carried out by the controller 50 in communication with the user interface 52. Alternative types of actuators are also contemplated, examples of which include pneumatic actuators, hydraulic actuators, and mechanical actuators. Control system 46 includes one or more emergency controls 44 and non-emergency controls 48 that cause the controller 50 to control the movement of the actuators 34-40 to move the seat 22, the backrest 24, and the leg rest 26, as will be discussed in more detail below. Although FIG. 3 illustrates emergency control 44 and non-emergency control 48 as being separate from user interface 52, it will be understood that in some embodiments, one or both of these controls 44 and 48 are integrated into one or more of the user interfaces 52. In still other embodiments, more than one emergency control 44 and/or non-emergency control 48 are included.

User interface 52 may be constructed in the same manner as, operate in the same manner as, and/or carry out any one or more of the same functions that are carried out using the control panels disclosed in any of the following commonly assigned U.S. patent applications: Ser. No. 14/838,693 filed Aug. 28, 2015 by inventors Daniel Brosnan et al. and entitled PERSON SUPPORT APPARATUS WITH ACTUATOR BRAKE CONTROL; Ser. No. 14/549,006 filed Nov. 20, 2014 by inventors Richard Derenne et al. and entitled PERSON SUPPORT APPARATUSES WITH VIRTUAL CONTROL PANELS; Ser. No. 15/162,653 filed May 24, 2016 by inventors Michael Hayes et al. and entitled USER INTERFACES FOR PATIENT CARE DEVICES; Ser. No. 15/170,979 filed Jun. 2, 2016 by inventors Aaron Furman et al. and entitled PATIENT SUPPORT APPARATUSES WITH DYNAMIC CONTROL PANELS; and Ser. No. 15/185,623 filed Jun. 17, 2016 by inventors Marko Kostic et al. and entitled PERSON SUPPORT APPARATUSES WITH LOAD CELLS, the complete disclosures of all of which are hereby incorporated herein by reference in their entirety.

The non-emergency movement and control of the actuators 34, 36, 38, and/or 40 of patient support apparatus 20 may also be carried out in accordance with the disclosure of commonly assigned, co-pending U.S. patent application Ser. No. 14/984,403 filed Dec. 30, 2015 by inventors Anish Paul et al. and entitled PERSON SUPPORT APPARATUS WITH PIVOTING BACKREST, the complete disclosure of which is also incorporated herein by reference.

Patient support apparatus 20 also includes a brake assembly 42 controlled by controller 50. Brake assembly 42 includes one or more braking mechanisms that are activated and de-activated by controller 50 to place one or more components in a braked or unbraked state. For example, in the illustrated embodiment, brake assembly 42 includes a braking mechanism that is controlled by controller 50 to selectively place one or more of the casters 32 in the braked and unbraked states.

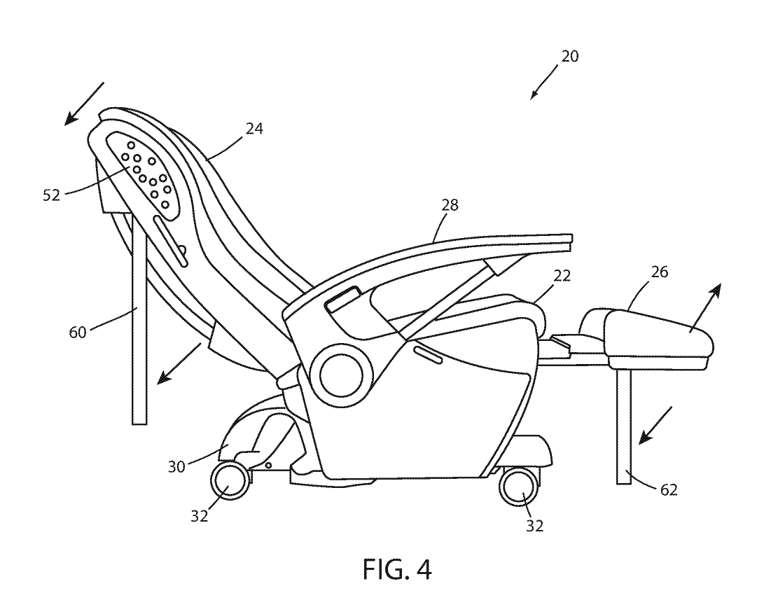

FIG. 4 illustrates patient support apparatus 20 shortly after emergency control 44 has been activated, but prior to patient support apparatus 20 reaching a generally flat orientation conducive for administering CPR to the occupant of patient support apparatus 20. More specifically, FIG. 4 shows patient support apparatus 20 when backrest 24 has been pivoted to the reclined position, leg rest 26 is pivoted to the extended position, a backrest support member 60 is deployed from the backrest 24, and a leg rest support member 62 is deployed from the leg rest 26. Backrest support member 60 is deployed to support backrest 24 and to stabilize patient support apparatus 20. Leg rest support member 62 is deployed to support leg rest 26 and to stabilize patient support apparatus 20.

In a hospital or other type of patient care center, patients who are using patient support apparatus 20 may experience an episode in which cardiopulmonary resuscitation (CPR) is performed on the patient. CPR is recommended to be performed on a patient who is supine on a generally horizontal, rigid surface. In such situations, activation of emergency control 44 automatically configures patient support apparatus 20 to a configuration that is conducive to, and stable enough for, performing CPR. Positioning of backrest 24 into the reclined position in which it is supported on the floor by backrest support member 60 can be referred to as the “CPR configuration”, although it will be understood that patient support apparatus 20 can be placed into the CPR configuration at times other than when CPR is being performed. The CPR configuration includes positioning of leg rest 26 into the extended position in which it is supported on the floor by leg rest support 62, although it will be understood that in some embodiments, the CPR configuration does not include positioning of leg rest 26 into the extended position.

In the CPR configuration, backrest 24 is reclined to a generally horizontal or flat orientation conducive for performing CPR on an occupant, although in some embodiments the CPR configuration may correspond to backrest 24 reclined to an angle relative to horizontal. While the embodiments are described in the context of positioning patient support apparatus 20 in a position conducive for performing CPR, it will be understood that other configurations are possible. For example, activation of emergency control 44 may automatically configure patent support apparatus 20 to a Trendelenburg position in which backrest 24 is positioned in a reclined position past horizontal such that an occupant's head is positioned below the occupant's pelvis. In other embodiments, the angle to which backrest 24 is reclined upon activation of emergency control 44 may be adjustable.

Backrest support member 60 can take on a variety of different forms and/or shapes. In the illustrated embodiment, backrest support member 60 is a leg or strut that is pivotably coupled at one end to backrest 24. Backrest support member 60 pivots or otherwise moves between (a) a stowed position in which backrest support member 60 does not provide support to the backrest 24, and (b) a deployed position in which backrest support member 60 contacts the floor, or other rigid structure, and provides stabilizing support to the backrest. In the stowed position, backrest support member 60 is positioned adjacent an exterior, rear surface of backrest 24 or stored within a cavity formed within backrest 24. Alternatively, backrest support member 60 can be in the form of a telescoping leg that is coupled at one end to backrest 24 and extends to support backrest 24 on the floor. Leg rest support member 62 is coupled to leg rest 26 and operates in a manner similar to backrest support member 60 to support leg rest 26 on the floor, or on another rigid structure. Backrest support member 60 and leg rest support member 62 may have a generally circular, rectangular, or other geometric cross-sectional shape. Backrest support member 60 and leg rest support member 62 may be the same or different.

The lengths of backrest support member 60 and leg rest support member 62 are fixed in one embodiment. In such embodiments, the fixed lengths are selected such that the support members 60, 62 contact the floor when backrest 24 and leg rest 26 are in the CPR configuration. Further, the fixed lengths correspond to seat 22 being in a predefined position, such as an unraised position. The predefined height can correspond to a different height in different embodiments. In another example, the length of the backrest and leg rest support members 60, 62 are adjustable such that backrest 24 and foot rest 26 can be supported on the floor at multiple different heights. In such embodiments, the backrest and leg rest support members 60, 62 may be in the form of telescoping legs adapted to lock at one or more predetermined lengths. Alternatively, or additionally, controller 50 can be programmed to control lift actuator 36 to raise or lower seat 22 to a predetermined height when backrest support member 60 is deployed. The predetermined height corresponds to a height at which backrest support member 60 is capable of contacting the floor to support backrest 24.

While only a single backrest support member 60 and leg rest support member 62 are illustrated in the embodiment shown in FIG. 4, it will be understood that patient support apparatus 20 can include more than one backrest support member 60 and/or leg rest support member 62.

Referring again to FIG. 3, control system 46 also includes one or more support member actuators 66a-b that are designed to selectively deploy and stow backrest support member 60 and leg rest support member 62. In the illustrated embodiment, control system 46 only deploys backrest support member 60 and leg rest support member 66 in emergency situations in response to activation of emergency control 44. Thus, if a user wishes to change the orientation of patient support apparatus 20 to, for example, the configuration shown in FIG. 2, he or she uses the one or more non-emergency controls 48 to control the various actuators 34, 36, 38, and/or 40 to move the patient support apparatus to this configuration. In so doing, neither backrest support member 60 nor leg rest support member 62 are deployed, even if backrest 24 is moved to the horizontal position and leg rest 26 is moved to the fully extended position.

When a user activates emergency control 44, however, one or more manual actuators 66a are activated so as to move back rest support member 60 and leg rest support member 62 to the deployed positions shown in FIG. 4. In some embodiments, one or more electrical actuators 66b may also be activated when a user activates emergency control 44. When electrical actuators 66b are included, they are designed so as provide powered assistance to the movement of backrest support member 60 and leg rest support member 62 to their deployed positions, but in no way resist the manual movement of these components via manual actuators 66a (such as by placing the actuator motors into a freewheeling state). In this manner, if patient support apparatus 20 is not plugged into an electrical outlet, does not have a battery, does have a battery but the battery is drained, or is otherwise not able to provide electrical activation of actuators 66b, the deployment of backrest support member 60 and leg rest support member 62 still takes place via manual actuators 66a. Electrical actuators 66b therefore reduce the manual effort and/or increase the speed at which backrest support member 60 and leg rest support member 62 deploy when electrical power is available and control system 46 is functioning normally, but do not hinder the movement of manual actuators 66a if electrical power is not available or there is an electrical problem with one or more components of control system 46.

In some embodiments, a separate manual actuator 66a is included for deploying and stowing backrest support member 60 and leg rest support member 62. In other embodiments, a single manual actuator 66a is included for deploying and stowing both backrest support member 60 and leg rest support member 62. Similarly, in some embodiments, separate electrical actuators 66b are included for deploying and stowing backrest support member 60 and leg rest support member 62, while in still other embodiments, a common electrical actuator 66b is used for deploying and stowing both backrest support member 60 and leg rest support member 62. Electrical actuators 66b can be motorized linear actuators that are designed to linearly extend and retract under the control of controller 50 in a manner similar to the actuators 34-40 described above. In some embodiments, the electrical actuators 66b are motorized rotary actuators.

Emergency control 44, in at least one embodiment, includes a handle or crank that is pulled, pushed, or otherwise physically moved in order to activate manual actuator(s) 66a (and in some cases also electrical actuator(s) 66b). The motive power for moving backrest support member 60 and leg rest support member 62 comes from, in one embodiment, the motion of the users hand when activating the handle or crank. That is, the handle or crank are mechanically linked to the backrest support member 60 and leg rest support member 62 such that movement of the handle or crank causes deployment of the backrest support member 60 and leg rest support member 62. Additionally, or alternatively, one or more stored physical energy devices (e.g. springs, coils, etc.) may be included that provide the mechanical energy of manual actuators 66a for moving backrest support member 60 and leg rest support member 62 to their deployed positions when emergency control 44 is activated.

In addition to activating manual actuator(s) 66a, the activation of emergency control 44 also causes an electrical signal to be sent to controller 50. In response to that signal, controller 50 controls electrical actuators 66b so as to help facilitate movement of the backrest support member 60 and leg rest support member 60 to their deployed positions. Also in response to that electrical signal, controller 50 determines the current position and orientation of seat 22, backrest 24, and leg rest 26. If backrest 24 is not in its CPR configuration, controller 50 sends a signal to backrest actuator 38 instructing backrest actuator 38 to move backrest 24 to its CPR configuration. Similarly, if seat 22 is not at its desired height (e.g. at its lowest height), controller 50 sends a signal to lift actuator 36 instructing it to move to the desired emergency height. Also, if seat 22 is not oriented at the correct angle for the application of CPR to the occupant of patient support apparatus 20, controller 50 sends a signal to seat actuator 34 instructing it to pivot seat 22 to the proper orientation. Additionally, controller 50 determines if leg rest 26 has been extended or not. If it has not been extended, controller 50 sends a signal to leg rest actuator 40 instructing it to extend leg rest 26 to its CPR configuration.

In some embodiments, control system 46 also includes manual actuators 66a for moving not only backrest support member 60 and leg rest support member 62, but also manual actuators 66a for moving one or more of seat 22, backrest 24, and leg rest 26. In such embodiments, the additional manual actuators 66a move the seat 22, backrest 24, and leg rest 26 to the desired emergency positions and/or orientations such that, in the absence of electrical power (or the presence of an electrical malfunction), patient support apparatus 20 is still able to be moved to an emergency configuration. If electrical power is available, the additional manual actuators 66a work harmoniously with the electrical actuators 34, 36, 38, and/or 40 such that seat 22, backrest 24, and leg rest 26 are moved by a combination of manual and electrical forces to their desired emergency positions and/or orientations. In some embodiments, the additional manual actuators 66a include a release on one or more of actuators 34, 36, 38, and/or 40 that, when activated, switches the motors of these actuators into a freewheeling mode whereby the spindle of the actuator is able to travel faster than the speed of the motor, thereby allowing manual forces to speed movement of the components (seat 22, backrest 24, and/or leg rest 26) faster than they would otherwise move in response to the motive forces supplied by the actuators' motors.

Controller 50 is programmed to coordinate the movement of backrest actuator 38 such that movement of backrest support member 60 occurs concurrent with the movement of backrest 24. For example, after emergency control 44 is activated, controller 50 controls backrest actuator 38 to move backrest 24 to the horizontal position while manual actuator 66a is simultaneously (or sequentially) moving backrest support member 60 to its deployed position. As noted, a separate manual actuator 66a may also be present that assists in the movement of backrest 24 to the horizontal position. Simultaneous (or sequential) deployment of leg rest support member 62 by manual actuator 66a and extension of leg rest 26 by leg rest actuator 40 (and a manual actuator 66a) may also occur.

After the emergency situation is over, controller 50 may control electrical actuator 66b to retract backrest support member 60 as backrest 24 is pivoted toward a particular upright position or subsequent to backrest 24 being pivoted into an upright position. Simultaneous (or sequential) retraction of leg rest support member 62 by an electrical actuator 66b and retraction of leg rest 26 by leg rest actuator 40 may also occur.

In some embodiments of control system 46, controller 50 does not activate electrical actuators 66b except when emergency control 44 is activated. In such embodiments, controller 50 responds to the activation of non-emergency control(s) 48 by activating one or more of actuators 34, 36, 38, and/or 40, but not by actuating any of actuators 66b. Thus, for example, if a user wishes to recline backrest 24 to a more horizontal orientation, he or she can manipulate a non-emergency control 48 that causes controller 50 to control backrest actuator 38 such that the backrest pivots to the desired orientation. In carrying out this control, controller 50 does not activate any electrical actuator 66b and backrest support member 60 is not deployed, even if backrest 24 moves to the fully horizontal orientation.

In an alternative embodiment, controller 50 is programmed to automatically control the electrical actuator(s) 66b even in non-emergency situations. Thus, if backrest 24 is reclined or leg rest 26 is extended, controller 50 also sends instructions to one or more electrical actuators 66b to cause backrest support member 60 and leg rest support member 62 to deploy. In still other embodiments, controller 50 may be programmed to deploy backrest support member 60 and/or leg rest support member 62 only in response to one or more predetermined conditions being met. For example, the predetermined condition may include an angle of the backrest 24 relative to the floor satisfying a predetermined threshold. The predetermined threshold can correspond to an angle of backrest 24 when backrest 24 is in the maximum reclined position or some other angle. In this manner, depending on the angle of recline of backrest 24, backrest 24 can be reclined with or without deployment of backrest support member 60. Similarly, leg rest support member 62 may be deployed based on an angle of leg rest 26 relative to the floor satisfying a predetermined threshold. As yet another alternative, leg rest support member 62 may be triggered for deployment when backrest support member 60 is deployed.

In non-emergency situations, when backrest 24 is reclined and backrest support member 60 remains in the stowed condition, backrest 24 cantilevers from the seat frame about the point at which backrest 24 is connected to the seat frame. The cantilevered backrest 24 may not provide sufficient stability and support for performing CPR on a patient in patient support apparatus 20. During CPR, the application of chest compressions to the patient applies a downward force to backrest 24 that could cause the cantilevered backrest 24 to wiggle or patient support apparatus 20 to tip. Any wiggling or other movement of backrest 24 during CPR compressions could decrease the effectiveness of the chest compressions. When emergency control 44 is activated, backrest support member 60 is deployed to support backrest 24 such that backrest 24 is no longer solely supported in a cantilevered manner. Instead, it is supported by backrest support member 60, which provides sufficient support and rigidity to backrest 24 to oppose the CPR forces and to resist tipping of patient support apparatus 20.

As noted, backrest 24 is moved into the CPR configuration at least by way of backrest actuator 38. During an emergency event in which CPR is to be performed, it is often important to begin CPR immediately. The electrical actuator 38 may not move as quickly as desired. In order to expedite this movement, manual force can be applied to move backrest 24 into the CPR configuration. Indeed, the weight of the patient leaning against backrest 24 can speed the movement of backrest 24 to the generally horizontal CPR configuration. The accelerated movement of backrest 24 by way of manual force is accomplished in some embodiments by placing the motor of actuator 38 into a freewheeling state to allow the backrest actuator 38 to be pivoted more quickly in response to manually applied downward forces on backrest 24. In another example, actuation of the emergency control 44 disengages backrest 24 from the electrical motor such that backrest 24 can be manually pushed into the reclined CPR configuration without utilizing the motorized actuator 38. Still further, one or more manual actuators 66b may be included that facilitate quick movement of backrest 24 to the reclined CPR configuration after emergency control 44 has been activated.

In some embodiments, backrest support member 60 automatically deploys when backrest 24 is reclined into the generally horizontal orientation of the CPR configuration, regardless of whether or not an emergency situation is present. In such embodiments, backrest support member 60 provides support to backrest 24 any time backrest 24 is pivoted backward. In another embodiment, backrest support member 60 can be adapted to be manually deployed by a user manually pulling backrest support member 60 into the deployed position.

Leg rest 26 and leg rest support member 62 are adapted to move to the extended and deployed positions when emergency control 44 is activated. Leg rest 26 and leg rest support member 62 can move into the CPR configuration in the same manner as described above for backrest 24 and backrest support member 60. In one example, the activation of emergency control 44 activates a manual actuator 66a that deploys leg rest support member 62. The activation of emergency control 44 also sends a signal to controller 50 that instructs leg rest actuator 40 to extend leg rest 40. In the absence of electrical power, or an electrical malfunction, emergency control 44 may be tied to a manual actuator 66a that releases leg rest actuator 40 such that leg rest 26 retracts to its stowed position under the weight of gravity and/or the patient's legs. Thus, in situations where electrical power is not available or cannot be used to move leg rest 26 to its extended position, control system 46 is designed to cause leg rest 26 to retract to its stowed position. CPR is still able to be performed while leg rest 26 is in its stowed position.

In an alternative embodiment, one or more sources of stored mechanical energy are contained within patient support apparatus 20 and used to move leg rest 26 to its extended position when emergency control 44 is activated and electrical power is not available. As yet another alternative, the weight of the occupant may be used to provide the motive mechanical force for extending leg rest 26 in the absence of electrical power. Still other variations are possible.

Movement of patient support apparatus 20 into the CPR configuration when emergency control 44 is activated may also include moving seat 22 to a predetermined height and controlling brake assembly 42 to place casters 32 in the braked state. The predetermined seat height corresponds to a height at which backrest support member 60 and leg rest support member 62 each contact the floor (after backrest 24 has reclined and leg rest 26 has extended). Seat 22 can be moved into the CPR configuration by the electrical motor of lift actuator 36 and/or through manual force. In one example, the height of seat 22 in the CPR configuration corresponds to the lowest height setting of seat 22. In such embodiments, gravity and/or the occupant's weight may be used to facilitate fast downward movement of the seat to its lowest height. However, other seat heights can be selected for the CPR configuration. Controller 50 is programmed to control brake assembly 42 to place casters 32 in the braked state upon activation of emergency control 44. In another example, brake assembly 42 includes a mechanical brake that is automatically applied to casters 32 when emergency control 44 is activated.

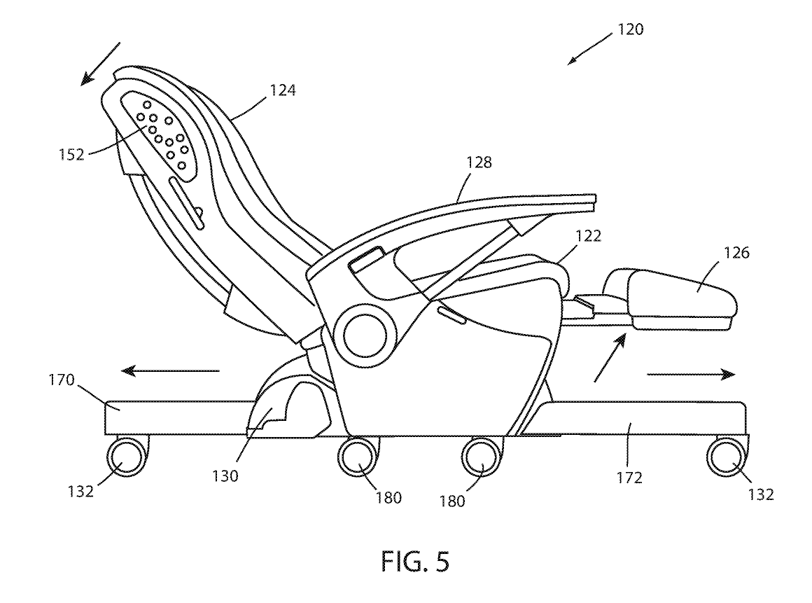

FIG. 5 illustrates a second embodiment of a patient support apparatus 120. Those components of patient support apparatus 120 that are the same as patient support apparatus 20 are identified with the same reference number increased by 100 and, unless otherwise stated, operate in the same manner. Those components that are new to patient support apparatus 120 are provided with a new reference number. Any of the functions and/or components of patient support apparatus 20 that are not present in patient support apparatus 120 can be incorporated into patient support apparatus 120 and vice versa.

Patient support apparatus 120 includes a base 130 having a rear base portion 170 and a front base portion 172 that are moveable with respect to the base 130. The rear and front base portions 170, 172 are moveable with respect to base 130 between extended and retracted positions to provide support and stability to patient support apparatus 120. FIG. 5 illustrates both rear base portion 170 and front base portion 172 in their extended positions. When rear base portion 170 and front base portion 172 are in their retracted position, patient support apparatus 120 may appear the same as how patient support apparatus 20 appears in FIG. 1 or FIG. 2.

Rear base portion 170 and front base portion 172 are controlled by control system 46 in the same manner as control system 46 controls backrest support member 60 and leg rest support member 62 of patient support apparatus 20. That is, rear and front base portions 170, 172 are moveable to the extended positions in response to a user activating emergency control 44. This movement occurs by way of one or more manual actuators 66a that extend rear and front base portions 170, 172. In some embodiments, rear and front base portions 170, 172 are connected to separate manual actuators 66a, while in other embodiments they are connected to a common manual actuator 66a. Further, in response to a user activating emergency control 44, controller 50 receives a signal of this activation and forwards instructions, in at least some embodiments, to one or more electrical actuator(s) 66b that extend rear and front base portions 170, 172 to their extended positions. This extension assists, but does not interfere with, the manual movement of rear and front base portions 170 and 172 by the manual actuator(s) 66a. The electrical actuators 66b may be motorized linear actuators that are designed to linearly extend and retract under the control of the controller 50 in a manner similar to the actuators 34-40 described above. Controller 50 also may also send additional instructions to actuators 34, 36, 38, and/or 40 in order to move patient support apparatus 120 to the CPR configuration, and/or the movement of seat 22, backrest 24, and/or leg rest 26 to the CPR configuration may be carried out by one or more manual actuators 66a.

Base 130 includes one or more floor supports 180 for supporting rear and front base portions 170, 172. Floor supports 180 may be casters or another type of support. A brake assembly 142 is controlled by controller 50 to selectively place the casters 132 and 180 in the braked and unbraked states. That is, in response to activation of emergency control 44, controller 50 switches casters 180 to their braked state, thereby resisting movement of patient support apparatus 20 across the floor. Controller 50 switches casters 132 to their unbraked state to allow front and rear base portions 170 and 172 to extend along the floor while being supported by casters 132. In some embodiments, emergency control 44 is also tied to a manual brake activation structure (not shown) that places casters 180 into a braked state. In this manner, the brakes will be activated even in the event of no electrical power, or an electrical malfunction. In one embodiment, base 130 includes a floor brake (not shown) that is stored in an undeployed position. In response to activation of emergency control 44, controller 50 selectively places the floor brake in a deployed position in which the floor brake contacts the floor to resist movement of patient support apparatus 20 across the floor.

In the illustrated embodiment, controller 50 only extends front and rear base portions 170 and 172 in response to activation of emergency control 44. When a user moves backrest 124 to a reclined position and/or extends leg rest 126 to the extended position using non-emergency control(s) 48, front and rear base portions 170 and 172 remain in their retracted positions. In an alternative embodiment, control system 46 may be modified to control rear base portion 170 to automatically extend whenever backrest 124 reclines or to automatically extend when backrest 124 reclines and an additional requirement is satisfied. The additional requirement may comprise backrest 124 reclining to an angle relative to the floor that satisfies a predetermined threshold. In one embodiment, control system 46 may be modified to control front base portion 172 to automatically extend whenever leg rest 126 extends or to automatically extend when leg rest 126 extends and an additional requirement is satisfied. The additional requirement may include rear base portion 170 extending or leg rest 126 extending to an angle relative to the floor that satisfies a predetermined threshold.

As with patient support apparatus 20, control system 46 of patient support apparatus 120 may also control seat actuator 34, lift actuator 36, backrest actuator 38, and leg rest actuator 40 in response to activation of the emergency control 44. Such control is carried out by manual actuation in one embodiment, and by a combination of manual and electrical actuation in another embodiment.

In addition to the control of actuators 34, 36, 38, and 40, control system 46 of patient support apparatus 120 also controls brake assembly 42 such that casters 132 are not braked in an emergency situation. That is, in response to activation of emergency control 44, control system 46 of patient support apparatus 120 releases the brake associated with casters 132 while also activating the brake associated with supports 180. The release of the brake associated with casters 132 allows front and rear base portions 170 and 172 to extend along the floor while being supported by casters 132. The activation of the brake associated with supports 180 ensures that patient support apparatus 120 generally remains stationary during an emergency. In some embodiments, controller 50 is programmed to switch casters 132 to their braked state once front and rear base portions 170 and 172 are in their extended positions.

In an alternative embodiment, controller 50 is programmed to coordinate movement of backrest 124 and rear base portion 170 such that rear base portion 170 extends outwardly as backrest 124 reclines. In one such embodiment, controller 50 is programmed to extend rear base portion 170 to a predetermined position in which a distal end of rear base portion 170 is generally vertically aligned with a distal end of backrest 124. In this manner, rear base portion 170 and backrest 124 have the same “footprint” when viewed from above. Alternatively, rear base portion 170 may be extended to a predetermined position such that the footprint of rear base portion 170 and backrest 124 are not the same. In another example, controller 50 is programmed to extend rear base portion 170 to multiple discrete or infinite positions based on the angle of recline of backrest 124. Controller 50 may also be programmed to extend front base portion 172 whenever leg rest 126 moves to its extended position. In one such embodiment, controller 50 extends front base portion 172 as far as the front edge of leg rest 126 such that front base portion 172 does not give patient support apparatus 120 a larger footprint when viewed from above than it would otherwise have due to the extension of leg rest 126. Alternatively and/or additionally, controller 50 may be programmed to extend front base portion 172 whenever rear base portion 170 moves to its extended position. Such extension may be independent of, or coordinated with, the movement of leg rest 126 to its extended position.

In some embodiments, front base portion 172 and leg rest 126 are mechanically coupled to rear base portion 170 and/or the backrest 124 such that when emergency control 44 is activated, movement of backrest 124 into the reclined position causes extension of front base portion 172 and leg rest 126. In some embodiments, front base portion 172 is adapted to only extend when emergency control 44 is activated and if leg rest 126 is already in the extended position. In such embodiments, if leg rest 126 is not extended, control system 46 may leave both leg rest 126 and front base portion 172 in their retracted positions.

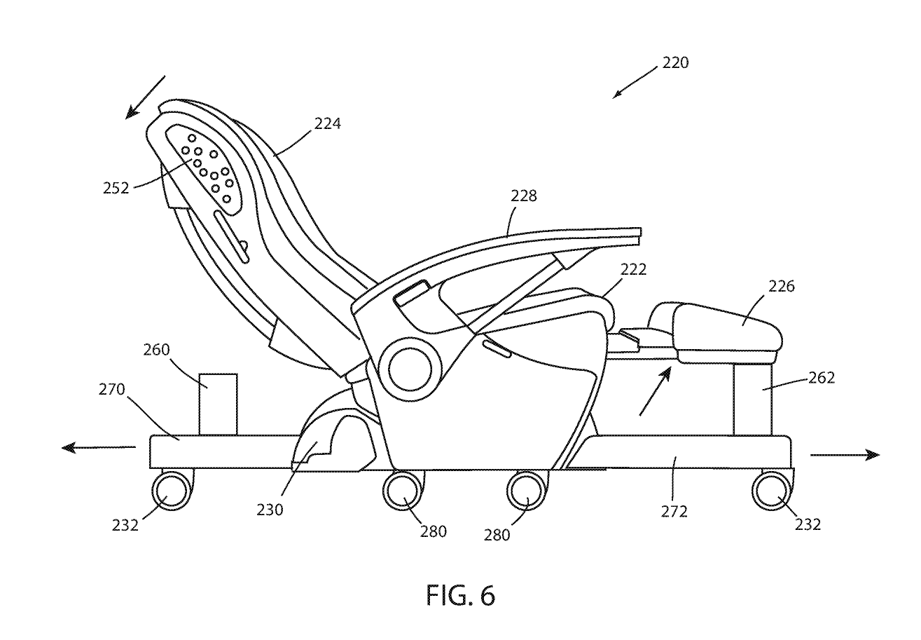

FIG. 6 illustrates a third embodiment of a patient support apparatus 220. Those components of patient support apparatus 220 that are the same as patient support apparatus 20 or 120 are identified with the same reference number increased by 200 or 100, respectively, and, unless otherwise stated, operate in the same manner. Those components that are new to patient support apparatus 220 are provided with a new reference number. Any of the functions and/or components of patient support apparatus 20 and/or 120 that are not present in patient support apparatus 220 can be incorporated into patient support apparatus 220 and vice versa.

Patient support apparatus 220 includes control system 46 and operates in any of the same manners described above with respect to patient support apparatus 120. Patient support apparatus 220 includes the same structures as patient support apparatus 120 with the exception of the addition of a backrest support member 260 and a leg rest support member 262. Backrest support member 260 is mounted to a rear base portion 270 and projects upward to support backrest 224 in the reclined position. Leg rest support member 262 is mounted to a front base portion 272 and extends upward to support leg rest 226 when leg rest 226 is extended. In this manner, backrest support member 260 provides support and stability to backrest 224 when backrest 224 is in the reclined position, and leg rest support member 262 provides support and stability to leg rest 226 when leg rest 226 is extended. This support and stability is in addition to the stability provided by the extended rear base portion 270 and extended front base portion. The additional support and stability can be particularly beneficial when the patient support apparatus 220 is in the CPR configuration and chest compressions are being applied to the occupant of patient support apparatus 220. As with the other patient support apparatuses described herein, the extension of rear and front base portions 270 and 272 may only occur in response to the activation of emergency control 44. In such embodiments, the use of non-emergency controls 48 to pivot backrest 224 to its reclined position and/or extend leg rest 226 to its extended position does not cause control system 46 to extend rear and front base portions 270 and 272.

Backrest support member 260, as with backrest support member 60 of patient support apparatus 20, can have fixed or adjustable heights selected to engage a rear face of the backrest 224 when backrest 224 is reclined. Similarly, leg rest support member 262, as well as leg rest support member 62 of patient support apparatus 20, can have a fixed or adjustable height selected to engage a rear face of leg rest 226 when leg rest 226 is extended.

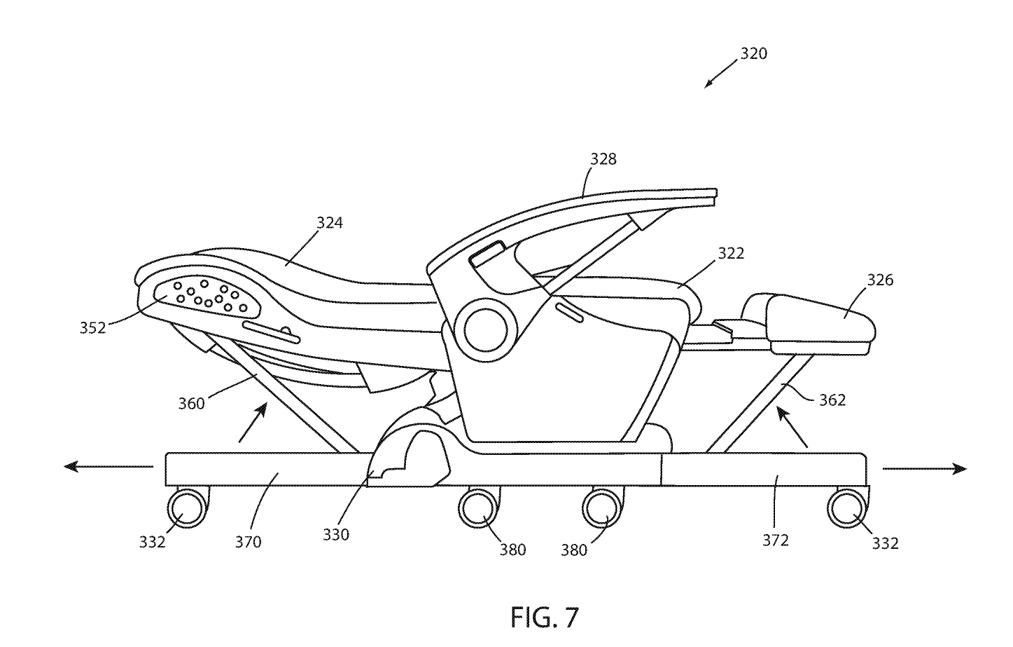

FIG. 7 illustrates another embodiment of a patient support apparatus 320. Those components of patient support apparatus 320 that are the same as patient support apparatus 20, 120, or 220 are identified with the same reference number increased by 300, 200 or 100, respectively, and, unless otherwise stated, operate in the same manner. Those components that are new to patient support apparatus 320 are provided with a new reference number. Any of the functions and/or components of patient support apparatus 20, 120, and/or 220 that are not present in patient support apparatus 320 can be incorporated into patient support apparatus 320 and vice versa.

Patient support apparatus 320 includes control system 46 and operates in any of the same manners described above with respect to patient support apparatus 120 and 220. Patient support apparatus 320 includes the same structures as patient support apparatus 220 with the exception that supports 260 and 262 have been replaced by supports 360 and 362. Supports 360 and 362 are adapted to pivot between a stowed positioned in which they do not provide support to backrest 324 and leg rest 326, respectively, and a deployed position in which they do provide support to backrest 324 and leg rest 326, respectively. In one embodiment, when supports 360 and 362 are in their stowed positioned, they are oriented generally horizontally and contained within a recess of rear base portion 370 and front base portion 372, respectively. This recess provides sufficient space to house supports 360 and 362 while rear and front base portions 370 and 372 are retracted to their stowed positions.

Control system 46 of patient support apparatus 320 uses one or more manual actuators 66a to pivot supports 360 and 362 to their deployed positions in response to activation of emergency control 44. In addition to utilizing manual actuator(s) 66a, control system 46 may also be configured to activate one or more electrical actuators 66b to help assist in the movement of supports 360 and/or 362, as well as rear and front base portions 370 and 372.

Various additional alterations and changes beyond those already mentioned herein can be made to the above-described embodiments. This disclosure is presented for illustrative purposes and should not be interpreted as an exhaustive description of all embodiments or to limit the scope of the claims to the specific elements illustrated or described in connection with these embodiments. For example, and without limitation, any individual element(s) of the described embodiments may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Any reference to claim elements in the singular, for example, using the articles “a,” “an,” “the” or “said,” is not to be construed as limiting the element to the singular.

What is claimed is:

1. A patient support apparatus comprising:
a base;
a seat supported by the base;
a backrest pivotable between an upright position and a reclined position; and
a backrest support member coupled to the backrest and adapted to move between a stowed position in which the backrest support member does not contact a support and a deployed position in which the backrest support member does contact the support.

2. The patient support apparatus of claim 1 wherein the support is a floor on which the patient support apparatus is positioned.

3. The patient support apparatus of claim 2 further comprising:
a leg rest pivotable between a retracted position and an extended position; and
a leg rest support member coupled to the leg rest and adapted to move between a stowed position in which the leg rest support member does not contact the floor and a deployed position in which the leg rest support member contacts the floor;
wherein the leg rest support member is adapted to move to the deployed position when the backrest support member moves to the deployed position.

4. The patient support apparatus of claim 1 wherein the backrest support member automatically moves into the deployed position when the backrest pivots to the reclined position.

5. The patient support apparatus of claim 2 wherein the backrest support member has a first end pivotably coupled to the backrest and a second end which abuts the floor when the backrest support member is in the deployed position.

6. The patient support apparatus of claim 1 wherein the backrest support member comprises a telescoping member.

7. The patient support apparatus of claim 1 further comprising:
a first actuator for pivoting the backrest;
a second actuator for moving the backrest support member;
a control system adapted to coordinate movement of the first and second actuators; and
a user interface having an electrical control, wherein activation of the electrical control causes the control system to pivot the backrest to the reclined position and to deploy the backrest support member.

8. The patient support apparatus of claim 1 further comprising:
a first control adapted to cause the backrest to pivot between the upright position and the reclined position without causing the backrest support member to move between the stowed and deployed positions; and
a second control adapted to cause the backrest support member to move from the stowed position to the deployed position.

9. The patient support apparatus of claim 2 wherein the seat is adapted to move to a height in which the backrest support member contacts the floor when the backrest support member is deployed.

10. A patient support apparatus comprising:
a base comprising a first base portion and a second base portion moveable with respect to the first base portion;
a seat supported by the base;
a backrest pivotable between an upright position and a reclined position; and
a control system adapted to move the second base portion between a retracted position and an extended position underneath the backrest in the reclined position.

11. The patient support apparatus of claim 10 further comprising:
a leg rest pivotable between a retracted position and an extended position; and
a third base portion moveable with respect to the first base portion;
wherein the control system is adapted to move the third base portion between a retracted position and an extended position underneath the leg rest in the extended position.

12. The patient support apparatus of claim 10 wherein the control system is adapted to move the backrest between the upright position and the reclined position independent of moving the second base portion between the retracted and extended positions.

13. The patient support apparatus of claim 10 further comprising:
a wheel coupled with the first base portion; and
a brake for the wheel coupled with the first base portion, the brake having a braked state and an unbraked state;
wherein the control system is adapted to place the brake in the braked state when the second base portion moves between the retracted and extended positions.

14. The patient support apparatus of claim 10 further comprising a backrest support member adapted to support the backrest on the second base portion.

15. The patient support apparatus of claim 14 further comprising:
a leg rest pivotable between a retracted position and an extended position;
a third base portion moveable with respect to the first base portion between a retracted position and an extended position underneath the leg rest in the extended position; and
a leg rest support member adapted to support the leg rest on the third base portion.

16. The patient support apparatus of claim 14 wherein the backrest support member is mounted to the backrest and adapted to move between a stowed position in which the backrest support member does not contact the second base portion and a deployed position in which the backrest support member engages the second base portion.

17. The patient support apparatus of claim 11 further comprising:
a backrest support member adapted to support the backrest on the second base portion; and
a leg rest support member adapted to support the leg rest on the third base portion;
wherein at least one of the backrest support member and leg rest support member is mounted on the second base portion and third base portion, respectively.

18. A patient support apparatus comprising:
a base;
a seat supported by the base;
a backrest pivotable between an upright position and a reclined position;
a backrest support member adapted to move between a stowed position and a deployed position, the backrest support member providing support to the backrest against downward forces when in the deployed position and the backrest support member not providing support to the backrest against downward forces when in the stowed position;
a first control adapted to cause the backrest to pivot between the upright position and the reclined position without causing the backrest support member to move between the stowed and deployed positions; and
a second control adapted to cause the backrest support member to move from the stowed position to the deployed position.

19. The patient support apparatus of claim 18 wherein the second control also causes the backrest to move from upright position to the reclined position if the backrest is not in the reclined position when the second control is activated.

20. The patient support apparatus of claim 19 wherein the backrest support member has a first end coupled to the backrest and a second end which contacts one of the base or a floor in the deployed position.

21. The patient support apparatus of claim 18 further comprising:
a leg rest pivotable between a retracted position and an extended position; and
a leg rest support member adapted to move between a stowed position and a deployed position, the leg rest support member providing support to the leg rest against downward forces when in the deployed position and the leg rest support member not providing support to the leg rest against downward forces when in the stowed position;
wherein the leg rest support member remains in the stowed position when the second control is not activated regardless of the position of the leg rest, and the leg rest support member moves to the deployed position when second control is activated.
